(19) United States
(12) Patent Application Publication
(10) Pub. No.: US 2020/0302077 A1
(43) Pub. Date: Sep. 24, 2020

(54) SYSTEM AND METHOD FOR SECURING ACCESS TO ELECTRONIC DATA

(71) Applicant: Jessie Cortez, Homeland, CA (US)

(72) Inventor: Jessie Cortez, Homeland, CA (US)

(21) Appl. No.: 16/646,807

(22) PCT Filed: Apr. 7, 2018
(86) PCT No.: PCT/US2018/026633

§ 371 Date: Mar. 12, 2020

Related U.S. Application Data
(60) Provisional application No. 62/557,931, filed on Sep. 13, 2017.

(51) Int. Cl. G06F 21/62; G06F 21/60; H04L 9/32; H04L 9/08; G06F 21/35

(52) U.S. Cl. CPC G06F 21/6218; G06F 21/602; H04L 9/0897; H04L 9/0861; G06F 21/35; H04L 9/3226

(57) ABSTRACT

The present invention is generally a system and method for securing access to electronic data. In exemplary embodiments, a personal computer may be secured by implementing encryption and a client device containing an encryption key. The client device may be a USB device configured with executable instructions that require a user of the personal computer to obtain an image scan matching a previously scanned image stored on the USB device. In exemplary embodiments, the item previously scanned and stored as the previously scanned image stored on the USB must be re-scanned every time prior to obtaining access. When a new scanned image is provided matching the previously scanned image, the user is authenticated and a decryption key supplied to decrypt the data on the personal computer.

### TECHNICAL FIELD OF THE INVENTION

The present invention relates in general to a system and method for securing access to electronic data or preventing unauthorized access to data stored in an electronic medium. More specifically, the present invention relates to an access authorization system and method in which at least one client electronic device, such as a mobile device, USB card or an ID card, may be required to access electronic data stored in a secured electronic device.

### BACKGROUND OF THE INVENTION

Keeping data secured is an ever-increasing challenge as technology advances and continues to develop. It is well known that electronic devices such as smartphones, tablets, personal computers, servers or entire computer systems may be targeted by unauthorized users in any number of ways. Sometimes, unauthorized users may simply seek to access electronic data stored in restricted systems to view or copy. For example, the electronic data may be intellectual content that is manipulated by these devices, such as, for example, when the data comprises music, movies, e-books, database information, or other forms of data that are privileged, copyrighted, proprietary or otherwise protected from unauthorized access. Other times, unauthorized users may seek unauthorized access to such electronic devices for obtaining control of a particular system or the electronic device itself. For example, access to the electronic data may be used to control the device itself, such as, for example, when the data comprises a computer software program.

In either scenario, the electronic data is valuable. In situations concerning intellectual property or other confidential data, the concern may be primarily of privacy. In situations concerning sensitive systems configured to operate one or more devices, the concern may be primarily of security or even safety. In either case, controlling the secured access to electronic data is desirable.

Various methods have been developed to secure an electronic device. For example, smartphones and tablets may implement passcodes that require a user input in order to authenticate the user. Passcodes may include words, numbers or alphanumeric combinations that are uniquely known to the authorized user, and without providing the passcode an unauthorized user will not be able to access the data stored in the electronic device. The problem with these measures of security is that passcodes—even when they are extremely unique—may nonetheless be deciphered and used to gain access. In some instances, knowing personal information of the user is enough for an unauthorized user to figure out the required passcode. In other instances, software may be implemented to derive or decipher the passcode autonomously; it is well known that such passcode breaking software is becoming more readily available.

More complex methods of verification include multistep-step verification where a user is required to have access to multiple devices. For example, a user may be required to have access to a first device—such as a smartphone—before being provided with a passcode or key to use on a second device—for example a personal computer with access to a secured server. The problem with these methods is that unauthorized users often find ways around multi-step verification including knowing or previously gaining access to an authorized user's email. For example, because these devices may all be connected in some way by accounts belonging to the authorized user, it is nevertheless possible for an unauthorized user to request passcodes via a known email of the authorized user commonly accessible via both devices.

Other methods implement biometric verification such as using facial recognition or other biometric sensors such as fingerprint sensors in order to authenticate an authorized user. For example, smartphones and computers implement touch sensors or cameras and corresponding software for implementing the desired biometric authentication. The problem with these systems is that they are costly and not always accessible to all users. Moreover, individuals may find that they cannot use a particular type of biometric sensor for one reason or other—for example individuals that have injuries may be able to use one type of biometric sensor and be precluded from using another type of biometric sensor. Furthermore, implementing a biometric verification system is largely dependent on the system having access to the required sensors. For example, electronic devices such as laptops or desktops used by most individuals are unlikely to be pre-equipped or easily retrofitted with the type of expensive sensors that are required for implementing biometric verification or authentication security systems.

Accordingly, there are several problems with the current state of the art that have not been adequately addressed. There is an inadequately addressed need for a system and method that prevents unauthorized access to electronic data stored in an electronic medium, in a manner that is undecipherable by unauthorized users, and that is cost efficient without requiring implementation of complex sensors and additional components. The problems persist because a need for preventing unauthorized access to electronic data has not been adequately met.

Therefore, there is a need for a system and method for securing access to electronic data that: does not depend exclusively on passcodes or other decipherable authentication methods, prevents a secured system from being deciphered autonomously using software tools, or that requires implementation of expensive and complex systems. It is to these ends that the present invention has been developed.

### SUMMARY OF THE INVENTION

To minimize the limitations in the prior art, and to minimize other limitations that will be apparent upon reading and understanding the present specification, the present invention describes a system and method for securing access to electronic data or preventing unauthorized access to data stored in an electronic medium.

Generally, the present invention involves securing an encrypted electronic device with an encryption method that requires connecting the encrypted electronic device to a client electronic device containing an encryption key, in order to access data stored in the encrypted electronic device. The encrypted electronic device may be, without limitation, a smartphone, tablet, laptop computer, personal desktop computer, a server, a network, or any other device or system that may be secured with encryption. The client electronic device may comprise a (second) smartphone, (another) tablet, (another) laptop computer, a USB device, an electronic identification card, a memory card or any other device capable of, or configured for, storing a set of executable instructions and an authenticating image. The executable instructions may typically launch a user interface such as, but not limited to, a graphical user interface (GUI), which requests an authorized user to scan and save an image via a scanning device in communication with the encrypted electronic device. The scanned image may have been previously stored on the client electronic device as an authenticating image associated with the encryption key to the encrypted electronic device. In order to access the data stored on the encrypted electronic device, an authorized user may be required to physically connect the client electronic device to the encrypted electronic device. Moreover, in exemplary embodiments, the authorized user may be further required to scan the same image matching the authenticating image prior to gaining access to the data stored on the encrypted electronic device. Accordingly, in some exemplary embodiments of the present invention, only a user with possession of the client electronic device, knowledge of the contents of the authenticating image, and knowledge of the location of the physical image matching the authenticating image will be capable of obtaining access to the encrypted electronic device. As will be explained below, varying levels of security may be implemented in order to facilitate the authentication process requiring more or less steps for authentication.

In one aspect of the invention, the client electronic device for storing the authenticating image may comprise a card device such as a memory card or an identification card configured to communicate via a connection means (such as a card reader) or wireless means such as implementing NFC methods. For additional security, each card may be furthered configured to communicate with a limited number or set of computers so that only those computers may be accessed via the card. In accordance with the present invention, the ID card typically includes a memory for storage of basic information, including but not limited to the authenticating image and the executable instructions that launch the user interface such as, but not limited to, the GUI, which requests the user of the ID to scan the image via the scanning device in communication with the encrypted electronic device.

A card device for securing access to electronic data, in accordance with an exemplary embodiment of the present invention, comprises: a wireless interface for communication with a processing device; and a microprocessor for executing one or more executable instructions stored in a storage module of the card device configured to: request a scanned image from a scanning device in communication with the processing device, wherein the processing device is configured with an encryption algorithm for securing electronic data stored in the processing device; generate an authenticating image from the scanned image; and associate the authenticating image with an encryption key to the processing device.

Another card device for securing access to electronic data, in accordance with another exemplary embodiment of the present invention, comprises: a security interface including a selectable means of inputting a passcode; a wireless interface for communication with one or more processing devices; and a microprocessor for executing one or more executable instructions stored in a storage module of the card device configured to: transmit a communication to a processing device in response to receiving a passcode via the security interface; request a scanned image from a scanning device in communication with the processing device, wherein the processing device is configured with an encryption algorithm for securing electronic data stored in the processing device; generate an authenticating image from the scanned image; and associate the authenticating image with an encryption key to the processing device.

Yet another card device for securing access to electronic data, in accordance with yet another exemplary embodiment of the present invention, comprises: a card reader interface including one or more light emitting diodes (LEDS); a communication interface for communication with one or more processing devices; and a microprocessor for executing one or more executable instructions stored in a storage module of the card device configured to: transmit an authorization code to a processing device configured to communicate with the card device via the card reader interface; request a scanned image from a scanning device in communication with the processing device, wherein the processing device is configured with an encryption algorithm for securing electronic data stored in the processing device; generate an authenticating image from the scanned image; and associate the authenticating image with an encryption key to the processing device.

A method for securing access to electronic data stored in a processing device, in accordance with practice of an exemplary embodiment of the present invention, comprises: connecting a client device to a processing device in communication with a scanning device, the processing device configured with an encryption algorithm for securing electronic data stored in the processing device; requesting a scanned image from the scanning device; generating an authenticating image from the scanned image; and associating the authenticating image with an encryption key to the processing device.

Another method for securing access to electronic data stored in a processing device, in accordance with practice of an exemplary embodiment of the present invention, comprises: connecting a client device to a processing device in communication with a scanning device, the processing device configured with an encryption algorithm for securing electronic data stored in the processing device; receiving a scanned image from the scanning device; matching the scanned image with an authenticating image stored in the client device; and providing an encryption key to the processing device in response to matching the scanned image with the authenticating image stored in the client device.

A device for securing access to electronic data, in accordance with an exemplary embodiment of the present invention, comprises: a storage module; and one or more executable instructions configured to: request a scanned image from a scanning device in communication with a processing device configured with an encryption algorithm for securing electronic data stored in the processing device; generate an authenticating image from the scanned image; and associate the authenticating image with an encryption key to the processing device.

An identification card for securing access to electronic data, in accordance with an exemplary embodiment of the present invention, comprises: a storage module; a wireless communication means for communication with one or more processing devices; and one or more processors for executing one or more executable instructions stored in the storage module configured to: request a scanned image from a scanning device in communication with a processing device configured with an encryption algorithm for securing electronic data stored in the processing device; generate an authenticating image from the scanned image; and associate the authenticating image with an encryption key to the processing device.

A system for securing access to electronic data, in accordance with an exemplary embodiment of the present invention, comprises: a scanning device; a processing device in communication with the scanning device and configured with an encryption algorithm for securing electronic data stored in the processing device; and a client device including: a storage module; and one or more executable instructions configured to: request a scanned image from the scanning device; generate an authenticating image from the scanned image; and associate the authenticating image with an encryption key to the processing device.

A system for securing access to electronic data, in accordance with another exemplary embodiment of the present invention, comprises: a server for supplying access to an encryption algorithm for securing electronic data on a processing device; a network for facilitating communication between the processing device and the server; a scanning device in communication with the processing device, wherein the processing device is configured to execute the encryption algorithm for securing electronic data stored in the processing device; and a client device including: a storage module; and one or more executable instructions configured to: request a scanned image from the scanning device; generate an authenticating image from the scanned image; and associate the authenticating image with an encryption key to the processing device.

It is an objective of the present invention to provide a means of securing electronic data, which minimizes or obviates the dependence on passcodes.

It is another objective of the present invention to provide a means of securing electronic data stored on a secured device, which implements a unique device separate from the secured device.

It is yet another objective of the present invention to provide a means of securing electronic data, which implements a scanning device.

These and other advantages and features of the present invention are described herein with specificity so as to make the present invention understandable to one of ordinary skill in the art.

### BRIEF DESCRIPTION OF THE DRAWINGS

The system and method for securing access to electronic data or preventing unauthorized access to data stored in an electronic medium as disclosed herein are further described in terms of exemplary embodiments. These exemplary embodiments are described in detail with reference to the drawings, which have not necessarily been drawn to scale in order to enhance their clarity and improve understanding of the various embodiments of the invention. Furthermore, elements that are known to be common and well understood to those in the industry are not depicted in order to provide a clear view of the various embodiments of the invention. These embodiments are non-limiting exemplary embodiments, in which like reference numerals represent similar structures throughout the several views of the drawings. The drawings that accompany the detailed description can be briefly described as follows.

FIG. 1 illustrates a system in accordance with an exemplary embodiment of the present invention, depicting several exemplary components that may be employed.

FIG. 2 illustrates a system in accordance with an exemplary embodiment of the present invention, depicting several exemplary components that may be employed.

FIG. 3(a)-3(b) illustrate components of an exemplary graphical user interface that may be utilized in accordance with the present invention.

FIG. 4 illustrates methods of securing access to electronic data in accordance with practice of some exemplary embodiments of the present invention.

FIG. 5 illustrates a method of securing access to electronic data in accordance with practice of an exemplary embodiments of the present invention.

FIG. 6(a) illustrates a block diagram of a card device, which may be used as a memory storage device or an identification card or ID card that is configured for storing an authenticating image, in accordance with the present invention.

FIG. 6(b) illustrates an exemplary card device having a passcode interface in accordance with the present invention.

FIG. 6(c) illustrates a card reader in accordance with the present invention for reading a card device such as the card illustrated in FIG. 6(b).

FIG. 7(a) illustrates an exemplary embodiment of a card device such as an ID card in accordance with the present invention.

FIG. 7(b) illustrates yet another exemplary embodiment of an ID card in accordance with the present invention.

FIG. 8 illustrates an exemplary embodiment of a user interface that may be launched per executable instructions stored in a card device in accordance with the present invention.

FIG. 9 illustrates an exemplary embodiment of a menu screen that may be made available via a user interface in accordance with the present invention.

FIG. 10(a) illustrates an exemplary embodiment of a user interface that may be used by administrators of a system in accordance with the present invention.

FIG. 10(b) illustrates an exemplary embodiment of a user interface that may be used by administrators of a system in accordance with the present invention.

### DETAILED DESCRIPTION OF THE DRAWINGS

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized, and changes may be made without departing from the scope of the invention. Wherever possible, the same reference numbers are used in the drawings and the following description to refer to the same or similar elements.

In the following detailed description, numerous specific details are set forth by way of examples in order to provide a thorough understanding of the relevant teachings. However, it should be apparent to those skilled in the art that the present teachings may be practiced without such details. In other instances, well known structures, components and/or functional or structural relationship thereof, etc., have been described at a relatively high-level, without detail, in order to avoid unnecessarily obscuring aspects of the present teachings.

Throughout the specification and claims, terms may have nuanced meanings suggested or implied in context beyond an explicitly stated meaning. Likewise, the phrase “in one embodiment/example” as used herein does not necessarily refer to the same embodiment and the phrase “in another embodiment/example” as used herein does not necessarily refer to a different embodiment. It is intended, for example, that claimed subject matter include combinations of example embodiments in whole or in part.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and or steps. Thus, such conditional language is not generally intended to imply that features, elements and or steps are in any way required for one or more embodiments, whether these features, elements and or steps are included or are to be performed in any particular embodiment.

The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present. The term “and or” means that “and” applies to some embodiments and “or” applies to some embodiments. Thus, A, B, and or C can be replaced with A, B, and C written in one sentence and A, B, or C written in another sentence. A, B, and or C means that some embodiments can include A and B, some embodiments can include A and C, some embodiments can include B and C, some embodiments can only include A, some embodiments can include only B, some embodiments can include only C, and some embodiments include A, B, and C. The term “and or” is used to avoid unnecessary redundancy. Similarly, terms, such as “a, an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

While exemplary embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the invention or inventions disclosed herein. Accordingly, the following detailed description does not limit the disclosure. Instead, the proper scope of the disclosure is defined by the appended claims.

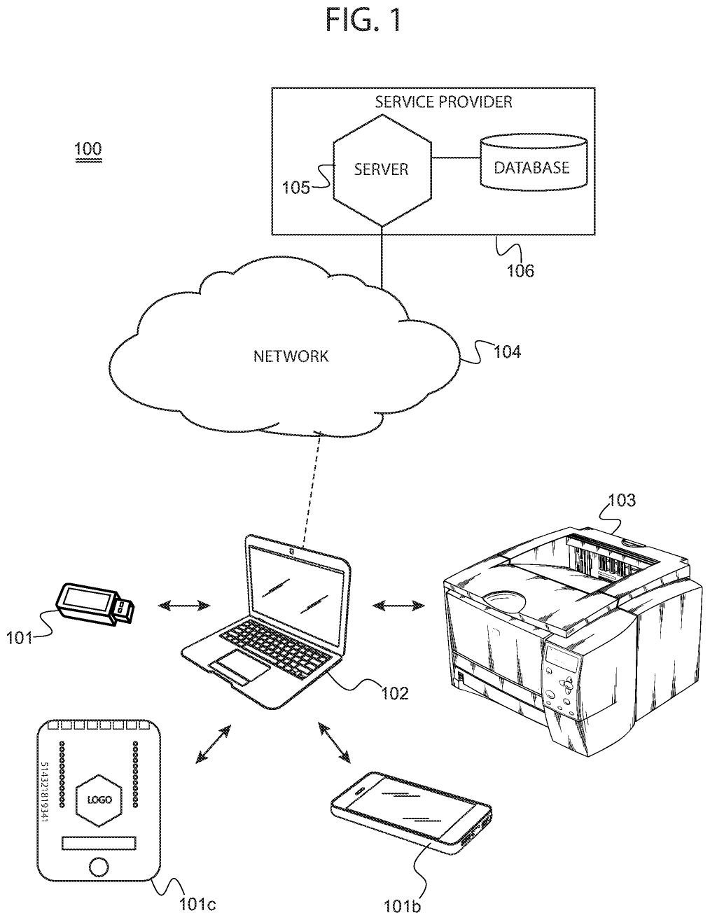

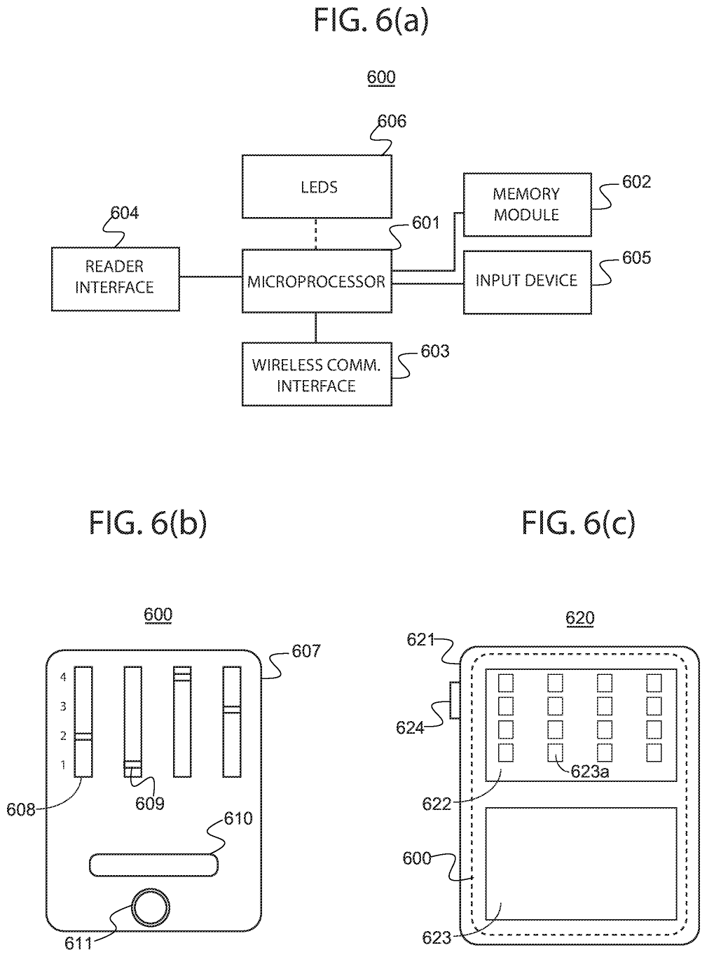

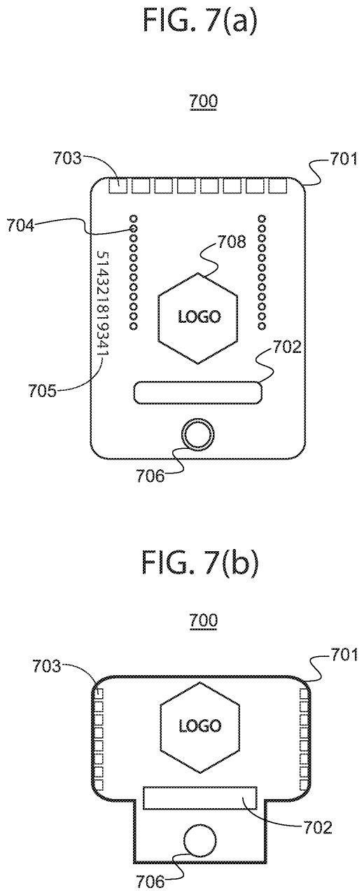

Turning now to the figures, FIG. 1 illustrates a system in accordance with an exemplary embodiment of the present invention, depicting several exemplary components that may be employed. More specifically, FIG. 1 illustrates system 100, which comprises at least one client electronic device such as client device 101 or client device 101b, or a card device 101c as will be discussed in more detail below with reference to figures FIG. 6(a), FIG. 6(b) and FIG. 7(a)-(b), a processing device such as a personal computer (processing device 102), and a scanning device such as an all-in-one printer-scanner or scanning device 103.

As will be explained further below, and without limiting, or deviating from, the scope of the present invention, system 100 may implement cloud-based solutions for software support and updates. As such, system 100 may comprise stand-alone software that does not require access to remote servers or may implement features that are facilitated but not necessarily required by access to remote servers. Accordingly, and only by way of example of possible embodiments, system 100 is shown as further comprising network 104, whereby remote access to server 105 of a service provider 106 may be accomplished from processing device 102.

The client electronic device may be a simple memory storage device such as a USB flash drive or client device 101. Alternatively, in other embodiments the client electronic device may involve a more complex device such as a smartphone or client device 101b. In either embodiment, the client device typically comprises a memory or storage module for storing software or a set of one or more executable instructions configured to implement the security features in accordance with the present invention. In some embodiments, client device 101 contains an encryption algorithm for processing device 102 to download and implement. In other exemplary embodiments, client device 101 includes a link, an address, or instructions to connect processing device 102 with server 105 via network 104 in order to obtain the encryption algorithm in accordance with the present invention.

Client device 101b may be a smartphone or table. In such exemplary embodiments, as will be discussed further below, client device 101b may utilize a smartphone or mobile application in order to execute executable instructions that may otherwise be processed by processing device 102. In such embodiments, client device 101b may, rather than rely on scanning device 103, utilize its own image capturing capabilities by, for example, utilizing a camera employed by client device 101b. In such embodiments, processing device 102 may be granted access to said camera via, for example, the mobile application employed by client device 101b.

Card device 101c may comprise a housing similar to that of a credit card or identification card. The housing may house a wireless interface for communication with a processing device, and a microprocessor for executing one or more executable instructions stored in a storage module of the card device configured to request a scanned image from a scanning device in communication with the processing device, wherein the processing device is configured with an encryption algorithm for securing electronic data stored in the processing device; generate an authenticating image from the scanned image, and associate the authenticating image with an encryption key to the processing device.

In exemplary embodiments, the card device 101c may comprise a card reader interface including one or more light emitting diodes (LEDS); a communication interface for communication with one or more processing devices; and a microprocessor for executing one or more executable instructions stored in a storage module of the card device configured to: transmit an authorization code to a processing device configured to communicate with the card device via the card reader interface; request a scanned image from a scanning device in communication with the processing device, wherein the processing device is configured with an encryption algorithm for securing electronic data stored in the processing device; generate an authenticating image from the scanned image; and associate the authenticating image with an encryption key to the processing device.

Processing device 102 may be any type of processing device such as a smartphone, tablet, personal computer, laptop computer, desktop computer, or any computational device having electronic data stored therein. By way of example only, processing device 102 is illustrated as a laptop computer. As mentioned above, processing device 102 may be configured to communicate with server 105 in the event that access to server 105 is desirable to for example obtain an encryption algorithm or software in accordance with the present invention. Whether or not access to a remote server is implemented into system 100 however, processing device 102 should be suitable to handle or implement encryption for securing electronic data stored therein.

Scanning device 103 may be any type of scanning device that may be configured to communicate with processing device 102. As such scanning device may comprise a stand-alone scanner or an all-in-one device that includes a scanner as is well known and widely available. Preferably, the scanning device is capable of high quality scanning images in order to facilitate an image recognition algorithm employed by a set of one or more instructions stored in client devices 101, 101b and 101c, or processing device 102.

In either embodiment discussed above, once processing device 102 has been configured with encryption software, client device 101 (or client devices 101b and 101c) is preferably required to provide an encryption key that enables access to the electronic data stored in processing device 102. For example, and without limiting the scope of the present invention, client device 101 may supply processing device 102 with an encryption algorithm upon inserting the flash drive for the first time in processing device 102. Once the encryption software automatically downloads itself on the hard drive (i.e. whether by facilitating a remote connection to server 105 or by directly providing the encryption software to processing device 102 from client device 101), a set-up process may be initiated in order to generate an authenticating image that will be associated with or used as an encryption key in order to decrypt the electronic data encrypted by the encryption software.

As will be explained further below with reference to other figures, before providing access to the stored electronic data, an authorized user will need to connect client device 101 (or client devices 101b or 101c) to processing device 102. Upon detecting device 101 (or client devices 101b or 101c) a screen may be automatically launched providing the user with instructions to either set up the authenticating image or—if this step has already been set up and processing device 102 is already encrypted—to provide a scanned image matching the authenticating image previously stored the client device.

For example, and without limiting the scope of the present invention, a user may be required to locate an image that was previously scanned and used to create the authenticating image stored in client device 101 (or client devices 101b or 101c), and re-scan that image on a scanning device such as scanning device 103 in communication with processing device 102. Because only an authorized user knows the subject of the authenticating image, and only an authorized user knows the location of the original image used to create the authenticating image, access to the electronic data stored in processing device 102 is secured and impermeable to hacking attempts using live or automated hacking attempts based on deciphering passcodes. Moreover, because a new scanned image from scanning device 103 may be required prior to obtaining access, hacking tools will be ineffective insofar as such tools may be used to identify the image that was used to generate the authenticating image, since the original image must nonetheless be physically located and scanned at the time of the requested access to the electronic data. Of course, as will be discussed below, other embodiments may provide lesser restrictions and different security measures, or lesser restriction levels may be implemented in order to facilitate access to the electronic data requiring less strenuous steps.

In an exemplary embodiment, once the encryption software is downloaded to a hard drive of processing device 102, a small window may appear requesting the user to provide payment with credit card authorization or any other known means of electronic payment. In some embodiments, a membership fee may be employed in order to keep the encryption software updated and or any related customer services active on an ongoing basis. This may be employed with known techniques such as implementing agreement terms prior to a user continuing using the encryption software. In some embodiments, deactivation of membership services—whether due for non-payment or otherwise—may cause activation of the software to cease. In such embodiments, the user may continue to use processing device 102 however the encryption software may close out and the user informed that electronic data in processing device 102 is no longer protected. Various techniques for reminding the user may be implemented without deviating from the scope of the present invention.

Of course, in embodiments in which a membership scheme is utilized to keep software and or customer services active and updated, regular access to server 105 via network 104 may be required. In such exemplary embodiments, processing device may be connected to network 104 (for example the Internet) at all times, or at least seek a connection to server 105 at regular intervals.

Accordingly, in one exemplary embodiment of the present invention, system 100 comprises: a server 105 for supplying access to an encryption algorithm for securing electronic data on a processing device 102; a network 104 for facilitating communication between the processing device 102 and the server 105; a scanning device 103 (or in some embodiments as mentioned above client device 101b with image capturing capabilities) in communication with the processing device 102, wherein the processing device 102 is configured to execute the encryption algorithm for securing electronic data stored in the processing device 102; and a client device (101 or 101b or 101c) including: a storage module; and one or more executable instructions configured to: request a scanned image from the scanning device; generate an authenticating image from the scanned image; and associate the authenticating image with an encryption key to the processing device.

In other exemplary embodiments, however, access to remote server 105 is not necessary and the encryption algorithm or software does not require access to server 105 via network 104. Such embodiment is discussed in more detail below with reference to the next figure.

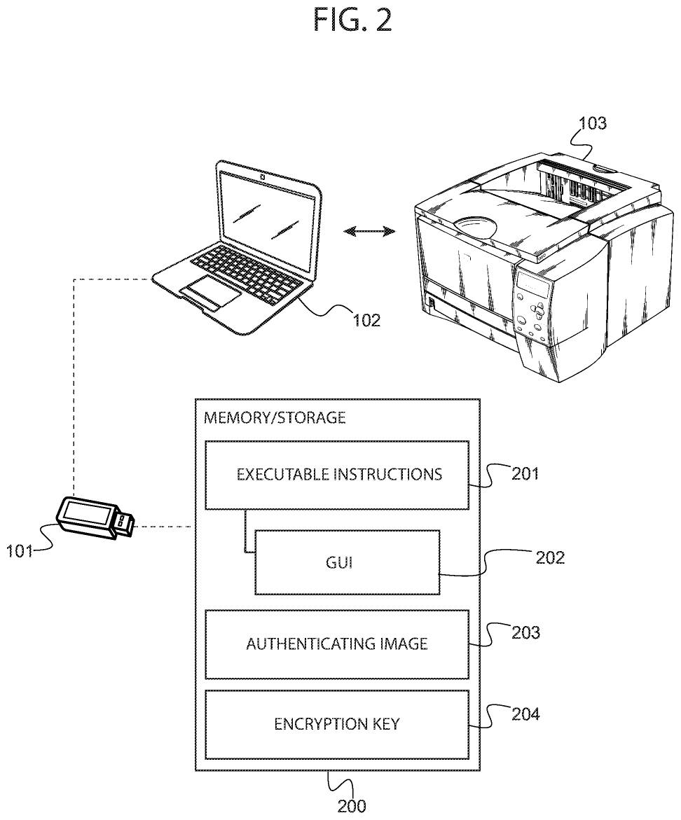

Turning now to FIG. 2, a system in accordance with an exemplary embodiment of the present invention, depicting several exemplary components that may be employed, is illustrated. More specifically, in the shown embodiment, system 100 comprises client device 101, processing device 102, and scanning device 103. No network or access to a remote server is required. Moreover, client device 101 is shown including memory module 200, which comprises one or more set of executable instructions 201 for: launching a graphical user interface or GUI 202; generating an authenticating image 203 from a scanned image that may be stored in memory module 201 of client device 101; executing an image recognition algorithm for matching a scanned image with authenticating image 203; and storing and or providing an encryption key 204 that is associated with authenticating image 203 in order to control access to the encrypted electronic data of processing device 102, which may have been encrypted using an encryption algorithm previously downloaded on a hard drive of processing device 102.

In such exemplary embodiment of the present invention, system 100, comprises: a scanning device 103; a processing device 102 in communication with the scanning device 103 and configured with an encryption algorithm for securing electronic data stored in the processing device 102; and a client device 101 including: a storage module 200; and one or more executable instructions 201 configured to: request a scanned image from the scanning device 103; generate an authenticating image 203 from the scanned image; and associate the authenticating image 203 with an encryption key 204 to the processing device 102. The executable instructions 201 may include instructions for launching GUI 202 in response to the client device 101 communicating with the processing device, wherein GUI 202 may be configured to initiate a scan or image request for a scanned or captured image in order to generate an authenticating image from the scanned or captured image and or uploading a scanned or captured image in order to match the scanned or captured image to a previously generated authenticating image.

Because the encryption software does not require access to a remote server, other means of providing customer service may be implemented without deviating from the scope of the present invention. For example, as will be discussed with reference to the next figure below, if a user requires help or instructions, one or more menus or help functions may be implemented via GUI 202.

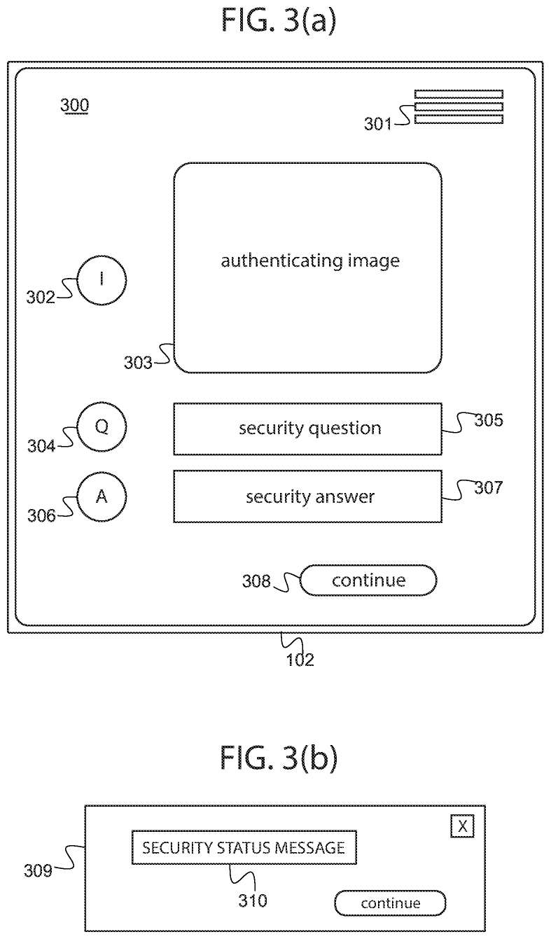

Turning now to the next figures, FIG. 3(a)-3(b) illustrate components of an exemplary GUI that may be utilized in accordance with the present invention. More specifically, FIG. 3(a) depicts a screen output 300 that may be generated by GUI 202 on processing device 102 once client device 101 has been connected and detected by processing device 102. FIG. 3(b) illustrates a type of notification that may be provided by the GUI.

Without limiting or deviating from the scope of the present invention, screen output 300 may include several data objects for facilitating numerous functions to install, activate, and implement the security features on an encryption software in accordance with the present invention. In some exemplary embodiments, these features may include: menu 301 that may further include access to help menus and instructions to users, as well as a selection of a security or restriction level associated with multilevel restrictions for granting access to the secured electronic data; one or more input buttons or indicators 302 for initiating and or indicating a scan request instruction for a scanned image in order to generate an authenticating image from a scanned image and or uploading a scanned image in order to match a scanned image to a previously generated authenticating image; image display box 303 for displaying an authenticating image or a scanned image to be matched with a previously stored authenticating image; one or more input buttons and or indicators 304 and display/text box 305 for requesting and displaying, respectively, a user-selected or automatically selected security question to be used in conjunction with an authenticating image; and one or more input buttons or indicators 306 and display/text box 307 for requesting and displaying, respectively, a user-selected or automatically selected security answer to be used in conjunction with the security question and authenticating image.

In exemplary embodiments, menu 301 may include a menu selection wherein users are provided with drop down menus to access and configure the devices and equipment such as scanning device 103, which will be used with processing device 102 in order to obtain canned images. Moreover, menu 301 may serve as a hub for user options including selection of security questions and answers to be displayed and or selected via dis-play/text boxes 305 and 307. In one embodiment, when a user clicks on the menu selection, a drop-down window may display several security levels.

In exemplary embodiments, a previously scanned image may be stored in client device 101's memory module 200 as an authenticating image 203. Accordingly, this image may be displayed in image display box 303. In some embodiments, the full image is displayed. In other embodiments, only a shadow, outline, perimeter, portion of the image, or any other hint, clue or partial disclosure of the content of the authenticating image may be provided to the requesting user in order to increase security. In yet other embodiments, no image is shown and only the scanned image is shown so that the requesting user is not provided with any information concerning the previously scanned image that was used to create the authenticating image stored in client device 101 and associated with the encryption key. In exemplary embodiments, a user may select what is and is not displayed in accordance with a selection of security levels that an authenticated user may desire to implement with processing device 102.

In some embodiments, when an authenticated user is already active on processing device 102 and decides to leave the computer without turning the device off, various types of features may be enabled such as requiring a new scan in order to regain access to the electronic data, or merely requiring a passcode during a brief period time, or any combination thereof. In some embodiments, additional information such as the security level enabled may be provided to the requesting user such as color schemed or text identifying the security level. Typically, the menu options screen would be locked to keep any unauthenticated users from altering the functions manually without the authenticating image, so that only the authenticated user can change the security level enabled.

In exemplary embodiments, screen output 300 may be a stand-alone window that is displayed on the screen. In other exemplary embodiments, output 300 may comprise a pop-up window including an exit button or a skip, the pop-up window displayed when a user tries to access protected or encrypted electronic data on the processing device. In yet other embodiments, a notification or message such as pop-up message 309 may be displayed in the event that the software is not running or that, for example, a membership expires rendering the processing device unprotected. Depending on the installation and or membership scheme that may be implemented in accordance with the present invention, the pop-up window 309 may include a message 310 warning a user of a status such as a non-active status when the membership or the software is not active. In some embodiments, this may occur for example, if the system is a membership-based system and the use has run out of funds or has not renewed activation. In other embodiments, this message may appear simply in the event that the device is unprotected because the software has been de-activated. As may be appreciated a user wishing to ignore the message may simply close the window, or alternatively follow directions included in the message itself (for example buttons and or instructions to link to an activation window or means to active or reactivate the software).

Finally, a simple submit or continue button 308 may be implemented in order to provide the scanned image obtained from scanning device 103. This issue a request for initiating an image recognition algorithm that matches the scanned image to a previously generated authenticating image 203. Where the scanned image matches the authenticating image, a request for an encryption key may be provided to client device 101 or may be automatically received from client device 101.

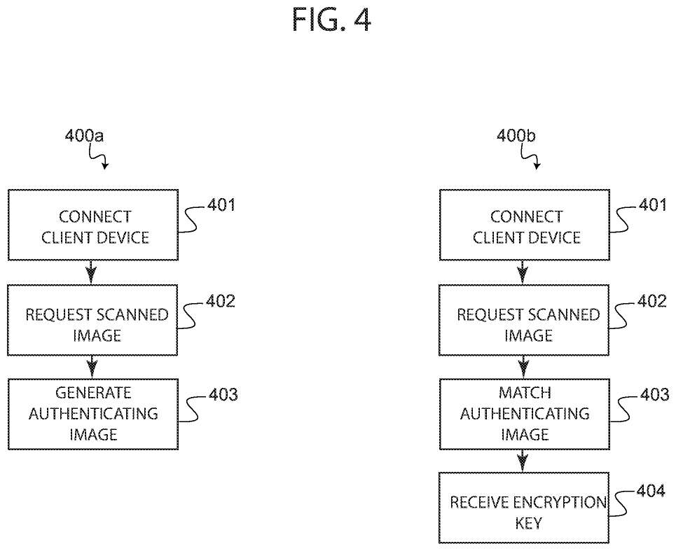

Turning now to the next figures, FIG. 4 illustrates a method of securing access to electronic data in accordance with practice of an exemplary embodiment of the present invention. More specifically, FIG. 4 depicts two flow charts illustrating a first method 400a for generating an authenticating image to use as an encryption key, and a second method 400b for accessing encrypted data on a processing device using an authenticating image. While various steps may be illustrated in a particular order, it is noted that other sequence of steps and orders are possible without deviating from the scope of the present invention.

Accordingly, method 400a for securing access to electronic data stored, in accordance with practice of an exemplary embodiment of the present invention, may comprise: connecting a client device to a processing device in communication with the scanning device (401), the processing device configured with an encryption algorithm for securing electronic data stored in the processing device; requesting a scanned image from the scanning device (402); generating an authenticating image from the scanned image or associating the authenticating image with an encryption key to the processing device (403).

Furthermore, method 400b for securing access to electronic data stored, in accordance with practice of an exemplary embodiment of the present invention, may comprise: connecting a client device to a processing device in communication with the scanning device (401), the processing device configured with an encryption algorithm for securing electronic data stored in the processing device; requesting a scanned image from the scanning device (402); matching an authenticating image from the scanned image with an authenticated image stored in the client device or the processing device (403); and receiving an encryption key in response to matching the authenticated image or otherwise providing access to the encrypted electronic data stored in the processing device (404).

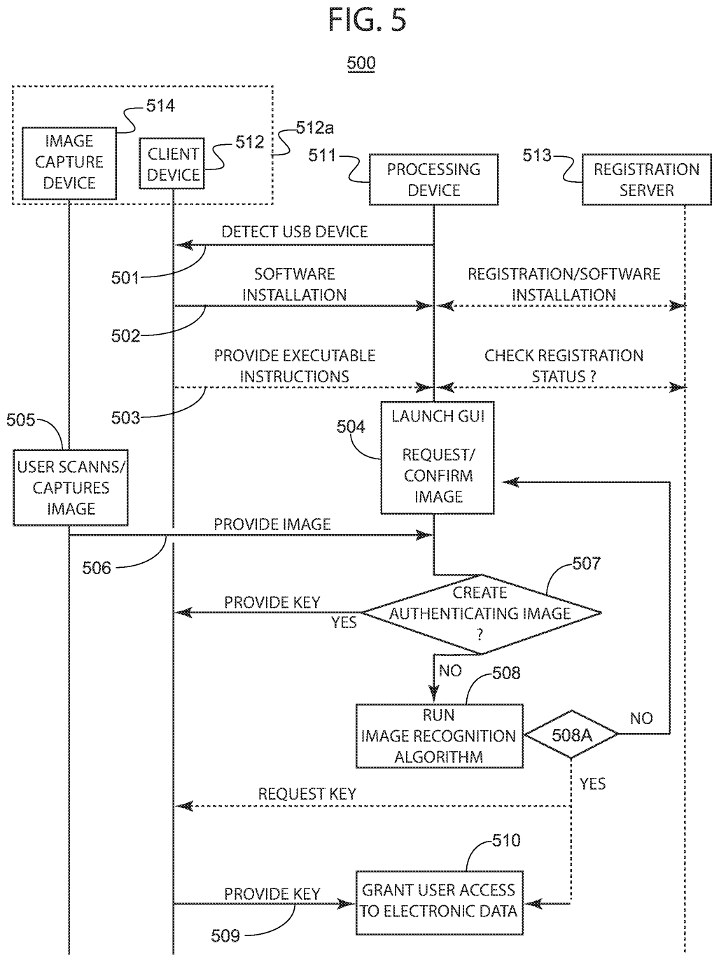

Turning now to the next figure, FIG. 5 illustrates a method of securing access to electronic data in accordance with practice of an exemplary embodiments of the present invention. More specifically, FIG. 5 illustrates a flow chart depicting method 500 for securing access to electronic data stored in processing device 511. While various steps may be illustrated in a particular order, it is noted that alternative orders or sequence of steps are possible without deviating from the scope of the present invention. Moreover, some steps may be depicted with dotted lines indicating optional or alternative steps for certain embodiments.

In exemplary embodiments, method 500 for securing access to electronic data stored in processing device 511 may be initiated by connecting a client device 512 to a processing device 511. In some exemplary embodiments, processing device 512 is in communication with a scanning or image capturing device 514 such as a scanner. In other exemplary embodiments, client device 512 includes an image capturing device 514 such as a camera—for example wherein the client device is a smartphone or client device 512a—in such embodiment, processing device 511 may have previously or concurrently requested permission to communicate with the image capturing device 514 or camera of client device 512a.

In either embodiment, processing device 511 is configured with an encryption algorithm or encryption software for securing electronic data stored in the processing device 511. Although the following steps are primarily described in an embodiment wherein client device 512 is not a smartphone but rather an identification card or a USB card, similar steps may be performed by a client device 512a which may be a smartphone including a camera or image capturing device 514; the primary difference is that in the former embodiment, the processing device 511 takes on the processing work of executing a program or set of instructions provided by client device 512 (as depicted by the flow chart of FIG. 5), whereas in the latter embodiment, it is the smartphone or client device 512a that may optionally take on the processing workload—in such exemplary embodiments, the steps of method 500 are nonetheless the same.

In step 501, once client device 512 is connected to processing device 511, client device 512—such as a USB device—may be detected. In some embodiments this may include connecting directly and physically to processing device 511. In other exemplary embodiments, this may include connecting wirelessly to processing device 511. In some exemplary embodiments, detecting client device 512 (or alternatively client device 512a) typically prompts the launching of a user interface such as a GUI.

In step 502, in some embodiments, if no encryption algorithm or software yet exists in processing device 511, then the encryption software may be provided. This may include providing access to a remote product registration server 513 (e.g. via link provided to processing device 511) or directly providing access to the encryption software via the client device (i.e. client device 512 or alternatively client device 512a may include enough storage for the encryption software). Moreover, in some embodiments, online registration of the product and payment may be required prior to, concurrently with or subsequent to the encryption software's installation on processing device 511.

In step 503, once the software is installed and or at subsequent times when client device 512 is connected to or in communication with processing device 511, the client device may provide access to executable instructions stored in a memory module of client device 512 for processing device 511 to execute. In some embodiments, the instructions are downloaded by the processing device, in other embodiments the processing device executes the executable instructions from the client device. In yet other exemplary embodiments client device 512a may execute the executable instructions instead, once processing device 511 has installed the encryption software—in such embodiment, client device establishes a communication with processing device 511 but does not necessarily provide executable instructions or any additional software.

In step 504, the executable instructions may cause a user interface such as a GUI to be launched. In some exemplary embodiments, every time the GUI is launched, registration or a membership activation status may be checked with a remote server. In some exemplary embodiments, a registration or a membership activation status may be checked upon detection of client device 512. In yet other exemplary embodiments, no registration or membership activation status check is required at all. Typically, in this step 504, the user is given instructions to proceed with either instructions requesting an authenticating image or instructions requesting a new image to generate an authenticating image for the first time. Instructions may vary without limiting the scope of the present invention, depending on several factors such as whether the client device has previously been set up for use with the processing device and or the level of security that may have been selectably implemented by a user.

For example, and without deviating from the scope of the present invention, in the event that client device 512 is being set up or connected for the first time, processing device 511 may request a scanned or captured image from a scanning or image capture device in communication with processing device 511. This may include instructions requesting the user use an image capture device or a scanner to capture or scan an image that will be used for generating an authenticating image. If client device 512 has been previously set up and processing device 511 recognizes the client device, then the instructions may include instructions requesting the user to capture or scan the previously provided image (assuming a higher level of security has been enabled). In other exemplary embodiments, a user may be instructed to view from a selection of outlined or shadowed images associated with a previously authenticating image stored in the client device (assuming a slightly less stringent level of security has been enabled enabled) in order to remind the user of the previously scanned or captured image used to generate an authenticating image. In yet other exemplary embodiments, a user may be instructed to select from a selection of images (assuming a lower level of security has been enabled), in which case the user may, for example, access a stored image on their client device 512a and use that image in step 506 below, skipping step 505. In yet other exemplary embodiments, a user may be instructed to select from a selection of images (assuming a lower level of security has been enabled) and require no other steps whatsoever. For a more secured system however, a higher level of security is enabled and step 505 is required every time access to electronic data on processing device 511 is sought.

In step 505, a user may capture an image using the image capture device 514 such as a camera on their client device 512a or a scanner in communication with processing device 511. As previously discussed above, if this is the first time the system and more specifically processing device 511 is being set up, then the user may simply scan and or capture an image or document using image capture device 514. If processing device 511 has been previously set up (i.e. an authenticating image has already been generated and associated with an authentication key to access processing device 511), then the user scans and or capture an image of the previously scanned and or captured image or document. Preferably, the image is of an existing image or an existing document. In exemplary embodiments, a user scans or takes a picture of a document easily accessible and in proximity to processing device 511. For example, and in no way limiting the scope of the present invention, processing device 511 may be a desktop in a user's office and, during an initial set-up, the user may scan an image of a sticky note that may be placed somewhere on their desk. After an authenticating image is generated (per the steps below) the user may place the stick note in a drawer, on their desk or anywhere of their choosing. During subsequent access requests to processing device 511, in step 505, the user will scan or take a picture of the sticky note. Because only the user knows what document (in this case the sticky note) was previously used as the authenticating image, access to electronic data on the desktop will be denied except to the user.

In step 506, client device 512 or client device 512a may provide processing device 511 with the captured or scanned image. If processing device 511 has been previously set up (i.e. an authenticating image has already been generated and associated with an authentication or encryption key to access processing device 511), then step 507 below may be skipped and an image recognition algorithm may be executed in step 508; otherwise, if this is the first time processing device 511 is being set up, then the user may be prompted to create an authenticating image that will be associated with an encryption key, in the following step 507.

In step 507, an authenticating image may be generated. Where an authenticating image may be generated, then additional instructions may be provided. For example, additional instructions may include selecting a level of security. Once an image is selected as the image for generating an authenticating image, the user may be asked to review and confirm. Moreover, the image is then associated with an encryption key generated by the encryption software of processing device 511 and stored. In some embodiments, the encryption key may be provided to the client device. In some embodiments, in order for the client device to access the provided encryption key, the document used to create the authenticating image must be re-scanned or a picture re-taken, as will be discussed further below.

In step 508, after an authenticating image that is associated with an encryption key have been created, an image recognition algorithm may be executed for matching the image provided in step 506 with an authenticating image stored in the client device (and or the processing device). In some exemplary embodiments, the image recognition algorithm may be performed by the processing device using executable instructions provided by the client device. In other exemplary embodiments, the client device executes instructions stored locally after capturing the image in step 506 in order to access the previously stored encryption key.

In either embodiment, a determination 508A may be made: in the event that the image provided in step 506 is not a match, then a new request under step 504 may be presented to the user via the GUI; if the image is successfully recognized, then in some embodiments, the processing device may request the previously provided key stored in the client device, in step 509; or in yet other embodiments, step 509 may be skipped and a recognition of the image by the image recognition software may simply grant user access in step 510—as such, an encryption key may be provided to the processing device in response to matching the scanned image with the authenticating image stored in the client device and the user may access the electronic data stored in processing device 511.

Accordingly, in exemplary embodiments, method 500 for securing access to electronic data stored may comprise of: connecting a client device to a processing device in communication with the scanning device, the processing device configured with an encryption algorithm for securing electronic data stored in the processing device; requesting a scanned image from the scanning device; matching the scanned image with an authenticating image stored in the client device; and providing an encryption key to the processing device in response to matching the scanned image with the authenticating image stored in the client device.

Turning now to the next set of figures, FIG. 6(a) illustrate a bloc diagram of a card device, which may be used as a memory storage device or an identification card or ID card that is configured for storing an authenticating image, in accordance with the present invention.

More specifically, this figure shows card device 600, including a processor such as a microprocessor or CPU 601 for executing one or more executable instructions stored in a memory module 602. The memory module 602 may also store an authenticating image in accordance with the present invention. A wireless communication interface 603 may provide wireless communication with processing devices such as laptops or desktop computers that may be encrypted.

As will be discussed in more detail below, the card device 600 may include a card reader interface 604 for coupling directly to card reading devices as an optional means of communicating with a processing device, as well as a secondary means of administering added security. The wireless interface 603 may implement a communications processor configured for any type of local wireless network communications and may use any number of known technologies such as Wi-Fi™, Bluetooth™, ZigBee™, near field communication (NFC), or any other known protocol to establish a wireless personal area network (WPAN) or any suitable local network. In exemplary embodiments, the wireless communications interface 603 implements NFC. In some embodiments, communications via NFC are only implemented after a user connects the card device 600 to a card reader. For example, and without limiting the scope of the present invention, card device 600 may be coupled directly to a computer that includes a card reader. Only when the card device 600 is coupled or connected to the card reader of the processing device, will the card device 600 communicate with the processing device and allow the processing device to execute an executable code stored in memory module 602. In exemplary embodiments, card device 600 includes an input device 605 as yet another added means of security. Such input device 605 typically activates the wireless communication between the card device and the processing device. The input device 605 may be implemented so that others that may be listening (with for example listening devices that may otherwise intercept a communication of an encryption key communicated from the card device to the processing device) will be unable to capture that information. Accordingly, in some embodiments, communications between the card device 600 and the processing device only occur upon a user pressing a button or input device 605. In yet other embodiments, communications between the card device and the processing device only occur upon a user connecting the card to a card reader via card reader interface 604 and pressing a button or input device 605 on the card device 600. In yet other embodiments, only a single one of these components is included with the card device—as such card device 600 may include only an input device 605 and not a reader interface 604, alternatively card device 600 may include a card reader interface 604 and not an input device 605. In preferred embodiments, card device 600 includes both to allow a user to set up a desired level of security for their system.

In exemplary embodiments, card device 600 comprises: a wireless interface for communication with a processing device; and a microprocessor for executing one or more executable instructions stored in a storage module of the card device configured to: request a scanned image from a scanning device in communication with the processing device, wherein the processing device is configured with an encryption algorithm for securing electronic data stored in the processing device; generate an authenticating image from the scanned image; and associate the authenticating image with an encryption key to the processing device.

In some exemplary embodiments, card 600 may include a user interface that may include LEDs 606 and or other indicators for input device 605 on a face of the card 600. For example, FIG. 6(b) illustrates an exemplary card device 600 having a passcode interface in accordance with the present invention. More specifically, this figure shows card device 600 including a housing 607 that is generally planar having a slim body much like a credit card. On one of the surfaces, the card device 600 may include a passcode interface 608 comprising of a means to input a passcode. In the shown embodiment, input interface or input device 605 includes a plurality of selectors or tabs 609 that may be positioned along an elongated channel at predetermined selectable stations that match one or more alphanumeric indicators. With this interface, a user may input a passcode by, for example, positioning each tab on each of the plurality of channels at a position matching the alphanumeric correspondent of the user's passcode. In the shown example, the user's passcode is 2143—for example, and without limiting the scope of the present invention. Moreover, card 600 may also include—as part of its input interface or input device 605—an activation button 610 that triggers sending or transmitting a communication with a processing device. In exemplary embodiments, card device's housing 601 may include an opening or keyring 605 to make the card easily transportable by a user—such as by coupling the card device to the user's keys or key ring 611.

Accordingly, a card device 600 may comprise: a security interface including a selectable means of inputting a passcode; a wireless interface for communication with one or more processing devices; and a microprocessor for executing one or more executable instructions stored in a storage module of the card device configured to: transmit a communication to a processing device in response to receiving a passcode via the security interface; request a scanned image from a scanning device in communication with the processing device, wherein the processing device is configured with an encryption algorithm for securing electronic data stored in the processing device; generate an authenticating image from the scanned image; and associate the authenticating image with an encryption key to the processing device.

FIG. 6(c) illustrates a card reader in accordance with the present invention for reading a card device such as the card 600 illustrated in FIG. 6(b). More specifically, this figure depicts a card reader 620, which may be coupled to a processing device such as a laptop computer or desktop. The card reader may itself communicate with the processing device wirelessly or may communicate via an interface such as a USB interface 624. The card reader may include a housing 621 that includes a reader interface 622 comprising a plurality of connectors or connector ports 623a for reading corresponding inputs selected from the passcode interface 608 of card device 600. Typically, the card reader 620 will include a means of receiving card device 600 such as a housing portion 623 configured to register with card device 600. In exemplary embodiments, a back face of card 600 lines up with reader interface 622 so that the plurality of connector ports 623a may read corresponding inputs on the back face of card 600 corresponding to selected tabs 609 of the passcode interface 608 of card device 600.

Turning now to the next set of figures, FIG. 7(a) illustrates an exemplary embodiment of a card device such as an ID card in accordance with the present invention. More specifically, card device 700 includes a housing 701 that is similar to that of a credit card with a planar and slim surface. On one end, the card device 700 may include a communication interface 703 for communicating with a processing device such as a laptop or desktop or a card reader. On a planar or flat surface of the housing 701, a plurality of LEDS 704 may light up to indicate a number of functions—such as saving a file, transmitting information, generally activity or an error in communicating with a processing device. In exemplary embodiments, a logo 708 and or an identification number 705 may be implemented. Typically, card device 700 will include an activation button 702 similar to the activation button of card device 600 for triggering a communication between the card device 700 and a processing device. Also, as with the exemplary embodiment of FIG. 6(b), card device 700 may include a keyring aperture or opening 706. FIG. 7(b) illustrates yet another exemplary embodiment of an ID card in accordance with the present invention. This embodiment may be a more compact version that does not include LED indicators. The housing may include alternative card reader interfaces 703 on opposite sides of the housing 701.

In exemplary embodiments, card device 700 comprises: a card reader interface including one or more light emitting diodes (LEDS); a communication interface for communication with one or more processing devices; and a microprocessor for executing one or more executable instructions stored in a storage module of the card device configured to: transmit an authorization code to a processing device configured to communicate with the card device via the card reader interface; request a scanned image from a scanning device in communication with the processing device, wherein the processing device is configured with an encryption algorithm for securing electronic data stored in the processing device; generate an authenticating image from the scanned image; and associate the authenticating image with an encryption key to the processing device.

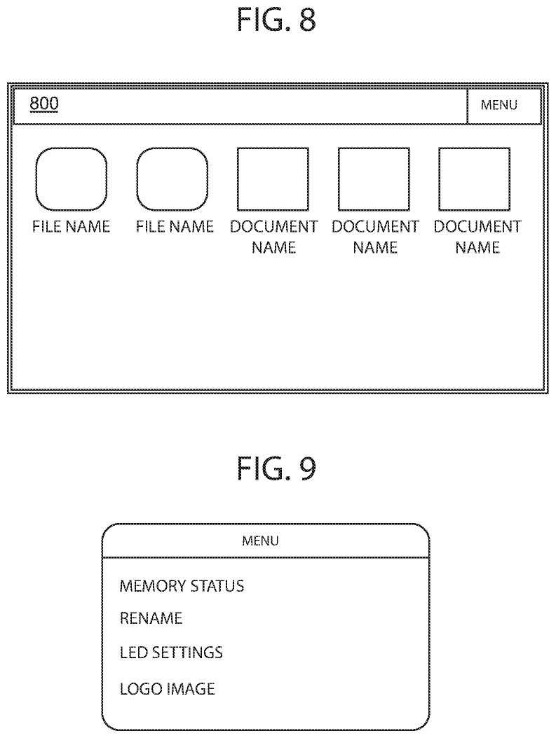

Turning now to the next figure, FIG. 8 illustrates an exemplary embodiment of a user interface that may be launched per executable instructions stored in a card device in accordance with the present invention. More specifically, this figure depicts a user interface 800 that may be launched on the processing device in order to manage storage on a card device such as card devices 600 and 700. Because these card devices may include storage space suitable for storing files and documents in addition to the executable instructions and authenticating image, a typical file manager may be implemented without deviating from the scope of the present invention. Accordingly, in exemplary embodiments, via user interface 800, a user may manipulate files or documents that may be stored on the card device.

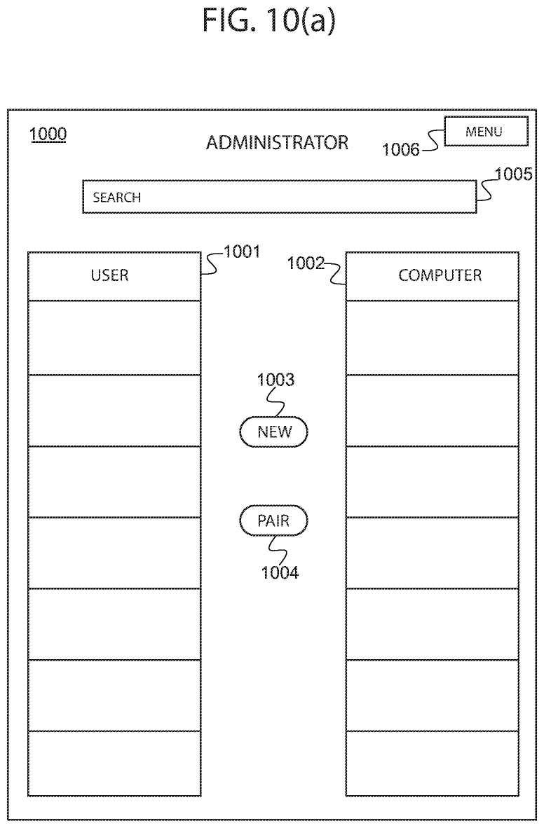

FIG. 9 illustrates an exemplary embodiment of a menu screen that may be made available via a user interface in accordance with the present invention. For example, and without deviating from the scope of the present invention, selecting a menu tab on user device 800 may open a window, screen or drop-down menu for accessing one or more settings of the card device. These settings may include view of memory or storage capacity or status, rename functions for stored files and documents, LED settings for settings concerning the LED indicators, and control of other features such as display of logos or information on the user interface.

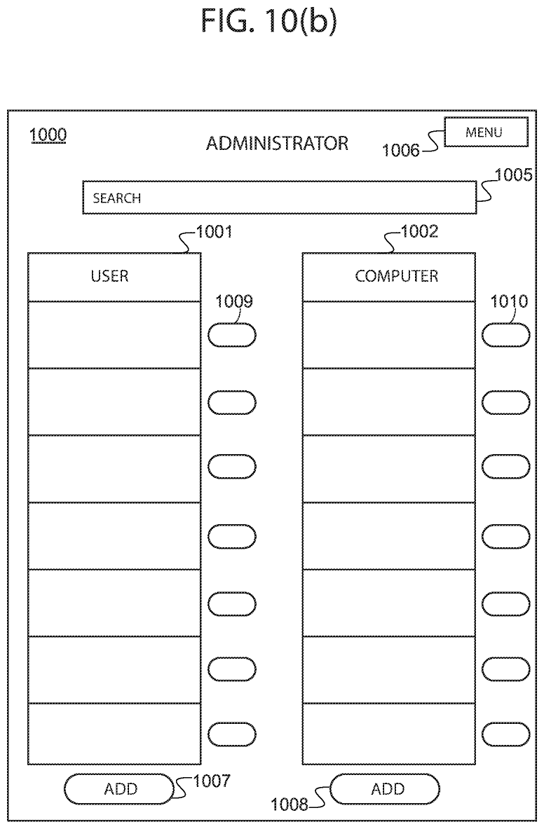

Turning now to the next set of figures, FIG. 10(a) illustrates an exemplary embodiment of a user interface that may be used by administrators of a system in accordance with the present invention; and FIG. 10(b) illustrates an alternative exemplary embodiment of such administrator user interface. More specifically, these figures depict user interface 1000, which includes a list of users 1001 that may be paired with a list of networked computers 1002, for example at a corporate office.

In exemplary embodiments, an administrator may use the user interface to pair or configure each computer with a card device that is issued to a user. The user interface may implement several functionalities such as, for example, and without limitation, adding a new user button 1003 or 1007, adding a new computer buttons 1004 or 1008, or adding or removing permissions for a user 1009 to access different computers in a particular network 1010. As may be appreciated by those skilled in the art, other functionalities such as search functionalities 1005, menu access buttons 1006 may be typically implemented.

In this way, not only may a user prevent others from accessing their computer at a particular location, but an administrator may further restrict use of one or more computers by designating permissions to one or more users for a plurality of computers. In such embodiments then, not only does the user require knowledge of the authenticating image but must know which computers they are authorized to use.

As may be appreciated by one skilled in the art, many variations on a system and method for securing access to electronic data in accordance with the present disclosure may be achieved without deviating from the scope of the invention. A system and method for securing access to electronic data has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

What is claimed is:

1. A system for securing access to electronic data, comprising:
an image capturing device;
a processing device in communication with the image capturing device, the processing device configured to execute an encryption algorithm for securing electronic data stored in the processing device; and
a client device configured to communicate with the processing device, including:
a storage module; and
one or more executable instructions to be executed by the processing device, the one or more executable instructions configured to:
request an image from the image capturing device;
generate an authenticating image from the image; and
associate the authenticating image with an encryption key to the electronic data stored on the processing device.

2. The system of claim 1, wherein the client device is a USB key.

3. The system of claim 1, wherein the client device is a card device including a security interface having a selectable means of inputting a passcode.

4. The system of claim 3, wherein the card device includes a wireless interface for communication with the processing devices.

5. The system of claim 3, further comprising a card reader interface connected to the processing device configured to communicate the processing device with the card device.

6. The system of claim 1, wherein the client device is a smartphone.

7. The system of claim 1, wherein the image capturing device is a scanner.

8. The system of claim 1, wherein the client device includes a copy of the encryption algorithm stored in the storage module.

9. The system of claim 1, wherein the one or more executable instructions are further configured to launch a graphical user interface (GUI) that provides instructions to a user for generating the authentication key.

10. The system of claim 1, wherein the one or more executable instructions are further configured to provide the authentication key to the client device.

11. The system of claim 1, further comprising a server for providing the processing devices with access to the encryption algorithm.

12. A method for securing access to electronic data, comprising:
connecting an image capturing device to a processing device, the processing device configured to execute an encryption algorithm for securing electronic data stored in the processing device;
receiving one or more executable instructions from a client device to be executed by the processing device; and
pursuant to the one or more executable instructions:
requesting an image from the image capturing device;
generating an authenticating image in response to receiving the image from the image capturing device; and
associating the authenticating image with an encryption key to the electronic data stored on the processing device.

13. The method of claim 12, further comprising launching a graphical user interface (GUI) in response to establishing a communication between the processing device and the client device.

14. The method of claim 13, further comprising receiving a security level selection from a user via the GUI.

15. The method of claim 13, further comprising displaying, via the GUI, the authenticating image for user verification.

16. The method of claim 12, further comprising matching the scanned image with an authenticating image stored in the client device.

17. The method of claim 13, further comprising providing an encryption key to the processing device in response to matching the scanned image with the authenticating image stored in the client device.

18. A system for securing access to electronic data, comprising:
a scanning device;
a processing device in communication with the scanning device, the processing device configured to execute an encryption algorithm for securing electronic data stored in the processing device; and
a USB device configured to communicate with the processing device, the USB device including:
one or more executable instructions to be executed by the processing device, the one or more executable instructions configured to:
request a scanned image from the scanning device;
generate an authenticating image from the scanned image; and
associate the authenticating image with an encryption key to the electronic data stored on the processing device.

19. The system of claim 1, wherein the one or more executable instructions include an image recognition algorithm.

20. The system of claim 18, wherein the one or more executable instructions are further configured to match the scanned image with an authenticating image stored in the client device.
